(19) United States
(12) Patent Application Publication
(10) Pub. No.: US 2010/0007090 A1
(43) Pub. Date: Jan. 14, 2010

(54) SEALING DEVICE

(75) Inventor: Naoto Kobayashi, Fukushima-shi (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/525,649

(22) PCT Filed: Jan. 24, 2008
(86) PCT No.: PCT/JP2008/050936

§ 371 Date: Aug. 3, 2009

(30) Foreign Application Priority Data
Mar. 30, 2007 (JP) 2007-090604

(51) Int. Cl. F16J 15/32

(52) U.S. Cl. 277/351

(57) ABSTRACT

To secure stability of the stacked sealing devices, a magnetic encoder-equipped sealing device has the slinger attached to either of two relatively rotating members and the lip seal attached to the other, the slinger has a magnetic encoder at one end face in the axial direction, the lip seal is formed by attaching a seal lip to an attachment ring and is slidably in contact with the slinger, an adhesion prevention projection, formed from a rubbery elastic body, is provided on the other end face in the axial direction of the attachment ring to prevent mutual adhesion of sealing devices when they are stacked, and the adhesion prevention projection (7) has a tapered cross-sectional shape in which an inner peripheral side-face (7a) of the projection (7) tilts relative to a rotation axis (O) at an angle greater than the tilt angle of an outer peripheral side-face (7b).

### CROSS-REFERENCE TO RELATED APPLICATIONS

This is a national stage of the International Application No. PCT/JP2008/050936 filed Jan. 24, 2008 and published in Japanese language.

### BACKGROUND OF THE INVENTION

1. Field of the Invention

The present invention relates to a sealing device in accordance with a sealing technique. The sealing device in accordance with the present invention is used, for example, as a hub bearing seal in a motor vehicle relevant field, or is used in each of relevant fields to a household electric appliance, an industrial machinery, a bicycle and the like.

2. Description of the Conventional Art

Conventionally, a sealing device 51 shown in FIG. 5A has been known. The sealing device 51 is used as a hub bearing seal in a bearing portion of a wheel suspension device for a motor vehicle, and is constructed by a combination of a slinger 52 installed to an outer peripheral side of a bearing inner ring 61 and a lip seal 54 installed to an inner peripheral side of a bearing outer ring 62.

The slinger 52 is a metal ring formed so as to have an approximately L-shaped cross section, and a magnetic encoder 53 is attached to an end surface thereof at one side in an axial direction (a right side in the figure). The lip seal 54 is made by attaching seal lips 56, which slidably come into close contact with the slinger 52 and are made of a rubber-like elastic material, to an attachment ring 55, and an adhesion prevention projection 57 made of the same rubber-like elastic material is provided on an end surface at the other side in the axial direction of (a left side in the figure) the attachment ring 55 to prevent adhesion when products are stacked. The adhesion prevention projection 57 is provided to prevent the adhesion as it's name suggests. In other words, if the adhesion prevention projection 57 not provided, there occurs a problem that the magnetic encoder 53 of one product 51 is adhered to the lip seal attachment ring 55 of an adjacent product 51 when a plurality of products 51 are stacked, and a bothersome detaching work arises. Accordingly, the adhesion prevention projection 57 serving as a spacer is provided for a previous adhesion preventing countermeasure. In this case, there are the adhesion prevention projections 57 of an annular type shown as in FIG. 5B, and a small projection dotted type as shown in FIG. 5C (refer to Japanese Unexamined Patent Publication No. 2001-141069).

However, the conventional art mentioned above has the following disadvantages.

In the annular type adhesion prevention projection 57 in FIG. 5B, there may occur a problem that the projection 57 collapses to an inner peripheral side due to a weight load when a plurality of products 51 are stacked. In this case, since the projection 57 deforms so as to narrow, it does not deform uniformly along circumference. Accordingly, stability in attitude of the stacked products is lost (it is impossible to stack the products 51 in parallel to each other).

Further, in the small projection dotted type adhesion prevention projections 57 in FIG. 5C, since the projections 57 are small and dotted, there is a case that the projections 57 collapse due to the weight load when a plurality of products 51 are stacked. In this case, since the projections 57 become of no use at all, the adhesion phenomenon mentioned above is caused.

### SUMMARY OF THE INVENTION

### Problem to be Solved by the Invention

The present invention is made by taking the points mentioned above into consideration, and an object of the present invention is to provide a sealing device with a magnetic encoder constructed by a combination of a slinger and a lip seal, in which an adhesion prevention projection does not collapse to an inner peripheral side when a plurality of products are stacked, whereby stability of the stacked products can be secured.

### Means for Solving the Problem

In order to achieve the object mentioned above, in accordance with a first aspect of the present invention, there is provided a sealing device constructed by a combination of a slinger installed to one of two relatively rotating members, and a lip seal installed to the other,

the slinger having a magnetic encoder on one end surface in an axial direction,

the lip seal being structured such that seal lips slidably coming into close contact with the slinger is attached to an attachment ring, and

the other end surface in the axial direction of the attachment ring being provided with an adhesion prevention projection made of a rubber-like elastic material to prevent adhesion when products are stacked,

wherein the adhesion prevention projection is formed in a tapered shape in its cross sectional shape, and an inner peripheral side surface thereof is formed in an inclined shape with respect to a rotation axis at an angle which is larger than that of an outer peripheral side surface.

Further, in accordance with a second aspect of the present invention, there is provided the sealing device as recited in the first aspect mentioned above, wherein a distal end portion of the adhesion prevention projection is formed in a rounded cross sectional shape.

Further, in accordance with a third aspect of the present invention, there is provided the sealing device as recited in the first aspect mentioned above, wherein the adhesion prevention projections in a circular arc shape are uniformly arranged at even distances in a circumferential direction.

Further, in accordance with a fourth aspect of the present invention, there is provided the sealing device as recited in the first aspect mentioned above, wherein a surface roughening work is applied to a distal end portion of the adhesion prevention projection.

### Effect of the Invention

In the sealing device in accordance with the present invention provided with the structure mentioned above, since the cross sectional shape of the adhesion prevention projection is formed in the tapered shape, and the inner peripheral side surface thereof is formed in the inclined shape with respect to the rotation axis at the angle which is larger than that of the outer peripheral side surface, the adhesion prevention projection tends to deform in the direction to expand to the outer peripheral side by the weight load applied thereto when a plurality of products are stacked, whereby the adhesion prevention projection can deform uniformly along the circumference. Therefore, it is possible to secure the stability in attitude of the stacked products (it is possible to stack the products in parallel to each other) (the first aspect).

Further, in addition to this, when the distal end portion of the adhesion prevention projection is formed in the rounded cross sectional shape (the second aspect), when the adhesion prevention projections in a circular arc shape are uniformly arranged at even distances in the circumferential direction (the third aspect), or when the surface roughening work is applied to the distal end portion of the adhesion prevention projection (the fourth aspect), a contact area of the projections with respect to the magnetic encoder is reduced. Accordingly, the projection is hard to be adhered to the encoder. Further, since the projection is formed in the annular shape or in the circular arc shape, the projection does not completely collapse, as is different from the small projection dotted type. Accordingly, it is possible to always achieve the adhesion preventing effect.

### BRIEF EXPLANATION OF DRAWINGS

FIG. 1 is a cross sectional view of a substantial part of a sealing device in accordance with an embodiment of the present invention;

FIG. 2A is an explanatory view showing an inclination angle of a tapered side surface at the outer peripheral side in the sealing device;

FIG. 2B is an explanatory view showing an inclination angle of a tapered side surface at the inner peripheral side;

FIG. 3 is a cross sectional view of a substantial part of a state in which a plurality of sealing devices are stacked;

FIGS. 4A, 4B and 4C are explanatory views of substantial parts of sealing devices in accordance with other embodiments of the present invention;

FIG. 5A is a cross sectional view of a substantial part showing an installation state of a sealing device in accordance with a conventional art;

FIG. 5B is an explanatory view of an annular type projection; and

FIG. 5C is an explanatory view of small projection dotted type projections.

### DETAILED DESCRIPTION OF PREFERRED EMBODIMENT

Next, a description will be given of an embodiment in accordance with the present invention with reference to the accompanying drawings.

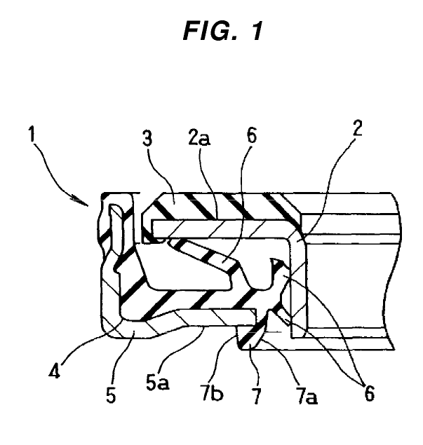

FIG. 1 shows a cross section of a substantial part of a sealing device 1 in accordance with an embodiment of the present invention. The sealing device 1 in accordance with the embodiment is used as a hub bearing seal in a bearing portion of a wheel suspension device for a motor vehicle, and is structured as follows.

First, the sealing device 1 is constructed by a combination of a slinger 2 installed to an outer peripheral side of a bearing inner ring, and a lip seal 4 installed to an inner peripheral side of a bearing outer ring.

The slinger 2 is a metal ring formed to have an L-shaped or approximately L-shaped cross section, and a magnetic encoder 3 is attached to an end surface 2a at one side in an axial direction (an upper side in the figure). The magnetic encoder 3 is formed in an annular shape by a rubber-like elastic material into which a magnetic material, powder is mixed, and is made to have a lot of magnetic poles in a circumferential direction, and a pulse signal is read by a sensor portion during rotation, whereby the magnetic encoder 3 is used for detecting a rotating speed, an angle of rotation and the like.

The lip seal 4 is formed by attaching a plurality of (three in the figure) rubber-like elastic material made seal lips 6, which slidably comes into close contact with the slinger 2, to an attachment ring 5, and an end surface 5a at the other side in the axial direction (a lower side in the figure) of the attachment ring 5 is provided with an adhesion prevention projection 7 made of the same rubber-like elastic material to prevent an adhesion when products are stacked. A rubber of the seal lips 6 is integrally connected to a rubber of the adhesion prevention projection 7 on an inner peripheral portion of the attachment ring 5, however, they may be formed separately from each other.

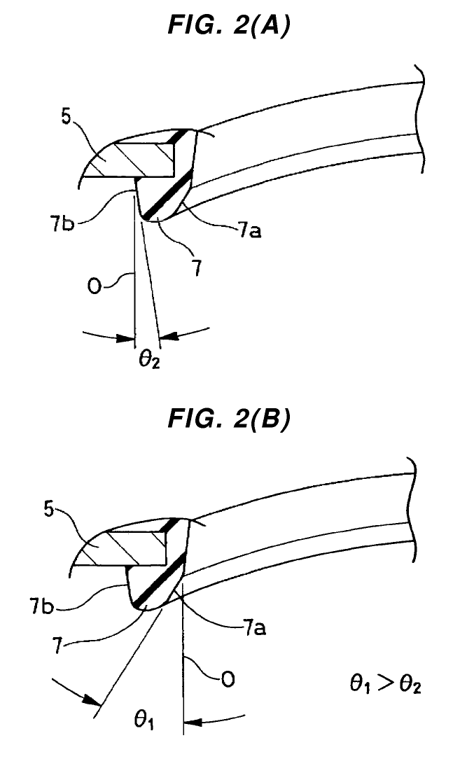

Further, in the embodiment mentioned above, the adhesion prevention projection 7 is formed in an annular shape and formed to have a tapered triangular or approximately triangular shape in its cross sectional shape, an outer peripheral side surface (an outer peripheral surface) 7b thereof is formed in a tapered surface shape which is reduced in diameter little by little toward a distal end while an inner peripheral side surface (an inner peripheral surface) 7a thereof is formed in a tapered surface shape which is enlarged in diameter little by little toward the distal end, and the inner peripheral side surface 7a is formed in such a shape as to be inclined with respect to a rotation axis (a center axis of rotation) O at a larger angle than that of the outer peripheral side surface 7b (the relation of θ1>θ2 is established, where θ1 is an inclination angle of the inner peripheral side surface 7a with respect to the rotation axis O, and θ2 is an inclination angle of the outer peripheral side surface 7b), as shown in FIGS. 2A and 2B. Further, a distal end portion of the adhesion prevention projection 7 is formed in a rounded cross sectional shape.

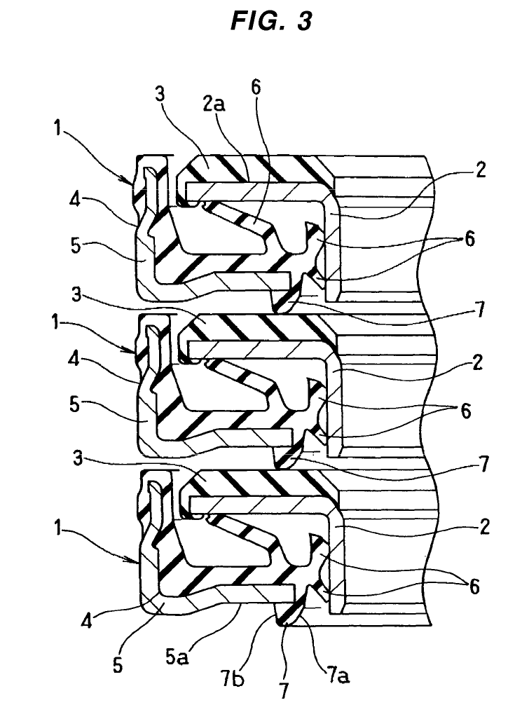

Since the sealing device 1 having the structure mentioned above is provided with the adhesion prevention projection 7 as mentioned above, it is possible to prevent a problem that the magnetic encoder 3 of one product 1 is adhered to the lip seal attachment ring 5 of the adjacent product 1 from occurring when a plurality of products 1 is stacked, as shown in FIG. 3. Further, in addition thereto, since the cross sectional shape of the projection 7 is formed in the tapered triangular or approximately triangular shape, and the inner peripheral side surface 7a is formed in the shape which is inclined with respect to the rotation axis O at the larger angle than that of the outer peripheral side surface 7b, the projection 7 tends to deform in the direction to expand to the outer peripheral side on the basis of an action of a load vector by a weight load applied thereto when a plurality of products 1 are stacked, whereby the projection 7 can deform uniformly along the circumference. Therefore, it is possible to secure stability in attitude of the stacked products, and, specifically, it is possible to stack a plurality of products 1 in parallel to each other.

Further, since the distal end portion of the projection 7 is formed in a rounded cross sectional shape, a contact area of the projection 7 with respect to the magnetic encoder 3 is set to be small. Accordingly, it is possible to effectively prevent the projection 7 from being adhered to the encoder 3.

Further, since the projection 7 is formed in the annular shape and is formed comparatively large in volume, the projection 7 does not collapse completely when a load is applied, as is different from the small projection dotted type projections in the conventional art mentioned above. Accordingly, it is possible to always achieve the adhesion preventing effect by the projection 7.

In this case, the shape of the projection 7 is purposely structured such that the projection 7 tends to collapse or expand to the outer peripheral side when a weight load is applied to the projection 7 from one side in the axial direction. Therefore, if the taper having the direction as mentioned above is set only to the inner peripheral side surface 7a, the outer peripheral side surface 7b at the opposite side may be formed in a cylindrical surface shape which is straight in the axial direction (θ2=0). Further, the tapered surface is not limited to that having a linear cross sectional shape, but may be formed to have a curved shape.

Further, the projection 7 can also be set to have a small contact area with respect to the magnetic encoder 3, in the following manners.

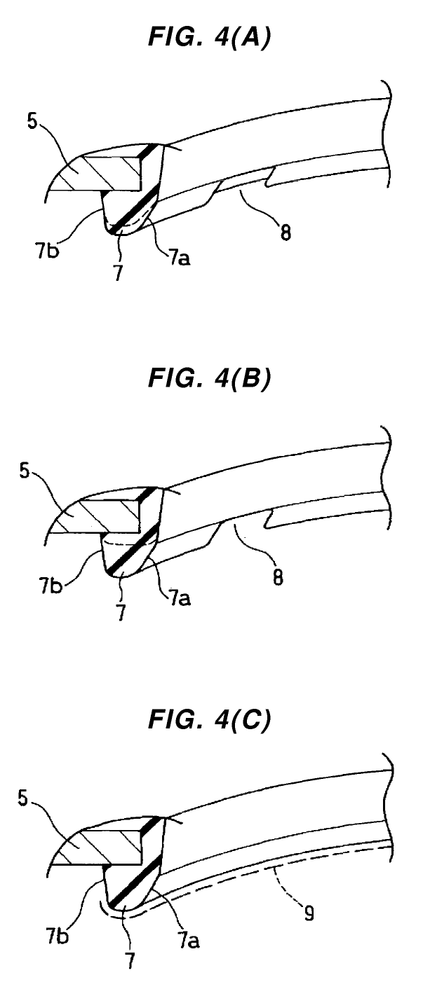

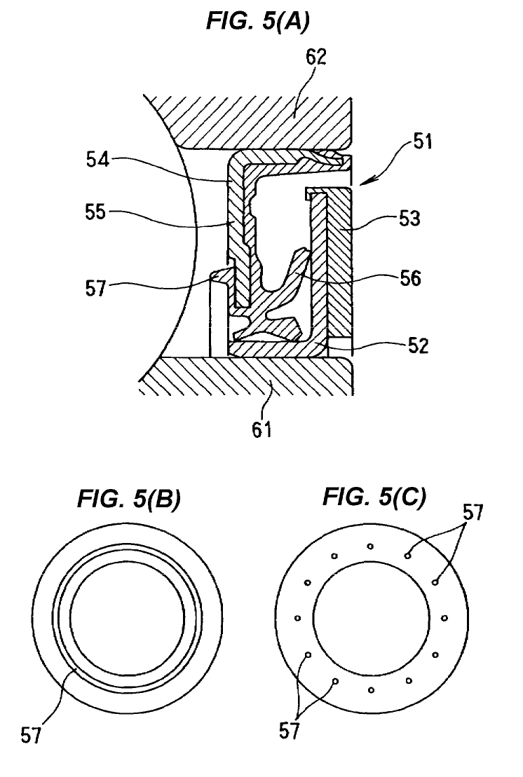

(1) As shown in FIG. 4A or 4B, notches (also called as groove portions) 8 are provided in some parts on a circumference of a distal end portion of the annular projection 7, thereby making a planar shape of the projection 7 into a circular arc shape extending in a circumferential direction, and arranging a plurality of such projections 7 uniformly at even distances. It is preferable that a level difference between the projection 7 and the notch 8 is set to 0.1 mm or more, and a width is set to 0.3 mm or more. The uniformly arranged number of the projection 7 is two or more.

(2) As shown in FIG. 4C, a surface roughening work 9 is applied to the whole or a part of the distal end portion of the projection 7. The roughening is preferably in a range between 2 and 500 μm. Further, it can be considered that the surface roughening work 9 is applied to the distal end portions in addition that the projections 7 are formed in the circular arc shape by providing the notches 8 as in the paragraph (1) mentioned above.

1.-4. (canceled)

5. A sealing device constructed by a combination of a slinger installed to one of two relatively rotating members, and a lip seal installed to the other,
said slinger having a magnetic encoder on one end surface in an axial direction,
said lip seal being structured such that seal lips slidably coming into close contact with said slinger are attached to an attachment ring, and
the other end surface in the axial direction of said attachment ring being provided with adhesion prevention projections made of a rubber-like elastic material to prevent adhesion when products are stacked,
wherein said adhesion prevention projections are formed in a tapered shape in their cross sectional shapes, and inner peripheral side surfaces thereof are formed in an inclined shape with respect to a rotation axis at an angle which is larger than that of outer peripheral side surfaces, and
wherein said adhesion prevention projections in a circular arc shape are uniformly arranged at even distances in a circumferential direction.

6. A sealing device constructed by a combination of a slinger installed to one of two relatively rotating members, and a lip seal installed to the other,
said slinger having a magnetic encoder on one end surface in an axial direction,
said lip seal being structured such that seal lips slidably coming into close contact with said slinger is attached to an attachment ring, and
the other end surface in the axial direction of said attachment ring being provided with an adhesion prevention projection made of a rubber-like elastic material to prevent adhesion when products are stacked,
wherein said adhesion prevention projection is formed in a tapered shape in its cross sectional shape, and an inner peripheral side surface thereof is formed in an inclined shape with respect to a rotation axis at an angle which is larger than that of outer peripheral side surface, and
wherein a surface roughening work is applied to a distal end portion of the adhesion prevention projection.
